(19) United States
(12) Patent Application Publication
(10) Pub. No.: US 2008/0270406 A1
(43) Pub. Date: Oct. 30, 2008

(54) SYSTEM AND METHOD FOR ADDING COMMENTS TO KNOWLEDGE DOCUMENTS AND EXPEDITING FORMAL AUTHORING OF CONTENT

(75) Inventors: Robert A. Flavin, Yorktown Heights, NY (US); Ryan K. Gunderson, Arvada, CO (US); Jonathan Lenchner, North Salem, NY (US); Laura Z. Luan, Scarsdale, NY (US); William L. Luken, Yorktown Heights, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/741,296

(22) Filed: Apr. 27, 2007

(51) Int. Cl. G06F 17/30; G06F 17/00; G06F 7/00

(52) U.S. Cl. 707/8; 707/E17.008; 715/230; 715/229

(57) ABSTRACT

A method for modifying knowledge documents, includes: retrieving an authored document per a client request; wiki-fying a copy of the retrieved authored document; accepting client comments into the wiki-fied authored document, while maintaining the integrity of the authored documents; notifying one or more authors of the authored document of the client comments in the wiki-fied copy of the authored document; modifying the authored document based on the determination of the one or more authors to the validity of the client comments; and replacing the authored document with the modified authored document.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to knowledge management, and more particularly to a method and system for users to modify knowledge documents with comments while preserving the integrity of each knowledge document as composed by the document authors.

2. Description of the Related Art

The recent growth in the use of “wikis” has focused attention on online collaborative editing of documents. A wiki is a website that allows visitors to add, remove, edit, and change content, typically without the need for registration. A wiki enables documents to be written collaboratively, in a simple markup language. A Wiki also allows for linking among a number of pages. The ease of interaction and operation of wikis have made them an effective tool for mass collaborative authoring. However, wikis suffer from weaknesses as well. Firstly, all wiki content is editable, and individuals may only add comments using simple markup language. In addition, all comments appear at the end of the document rather than in the context of the text being commented on. Moreover, there is not a notion of authorship per se in a wiki, with the idea that the author or authors of a document are notified when a change in content has been made.

In another system currently available for facilitating web-based commenting on portions of a document, the comments are displayed in context and stored distinctly from the text itself. However, the document author must declare the portions of the documents that are open to commenting in advance, and users must click on specific buttons to perform their editing. Moreover, authors are not notified when comments are made to their documents. An additional web-based approach involves storing metadata about specific web content that is part of a content management system apart from the content itself. In this approach the metadata is referred to as annotations, however there is no mechanism for inline annotation, or for annotations to be visible with the underlying web page. In addition, authorship is not recorded, and there is no notification back to the author when an annotation is created. Finally, there is an approach that relates to the tracking and adding contributions to the analysis of documents in a database and sharing such contributions to a community of interested individuals, and in particular to the annotating and publishing the analysis of patent documents to a community of inventors and patent professionals. This approach captures a very generic comment idea but does not employ the web, use in-place editing, or notify the document author in the event of a comment being added to the document.

FIG. 1 is a schematic diagram of an existing knowledge management system 10. A document repository 100 serves as a collection point for items called documents 110. The document repository 100 may be organized in the form of a database, and the document repository 100 may also be called a “Knowledge Base”. Each document 110 in the document repository may have many named properties. Each named property is called a field. Each document 110 contains at least one field composed of textual information encapsulating some form of information. Such fields are called knowledge fields. A knowledge field may consist of plain text, formatted text, sentences, paragraphs, lists, tables, or other structures.

Documents 110 originate as new documents 140 that are created by a document author (typically a person) 120. After a document author 120 composes a new document 140, a copy of the new document 140 may be deposited (published 150) in the Document Repository 100 and joins the collection of documents 110. The formal document authoring/composing system 130 may include a separate repository of unfinished documents, drafts, and other unpublished documents. The authoring/composing system 130 may involve additional people who may review and approve new documents 140 before they are deposited in the Document Repository 100. This review and approval processes may be employed to ensure the accuracy and reliability of each document 110 in the Document Repository 100.

After a new document 140 has been deposited/published 150 in the Document Repository 100, the information contained in each document 110 becomes accessible to a class of document repository client/user (typically people) 160. Each client/user 160 may access the information stored in the document repository 100 using a software means called a search-based knowledge base client 170. A client/user 160 who uses the knowledge base client software 170 may also be referred to as a knowledge base client/user 160. The knowledge base client software 170 allows the knowledge base client/user 160 to identify documents of interest by means such as keywords. A set of one or more keywords is defined as a query 175. Given a query 175, the knowledge base client software 170 searches the document repository 100 and creates a list of documents 180 that satisfy the query. The knowledge base client/user 160 may then select 185 one of the documents 110 identified by the knowledge base client software 170. The knowledge base client software 170 then presents the information contained in the document 110 as a selected document 190 to the client/user 160.

However, the knowledge management system 10 limits a client/user 160 to only reading the information associated with the document 110, and the client/user 160 is unable to make changes to the document 110. The document author 120 is the only party that is permitted to make changes to documents 110. If a document 110 contains errors, omissions, or other flaws, the value of the document to the client/user 160 is compromised. If the user 160 discovers an error, omission, or other flaw in a document (110, 190), the client/user 160 cannot make any corrections.

FIG. 2 illustrates an enhanced existing version of the knowledge management system 10 of FIG. 1. The knowledge management system 20 as seen in FIG. 2 provides a client/user 160 with a mechanism to report errors, omissions, or other flaws in a knowledge document based on a feedback process. The knowledge management system 20 includes all of the components (100-190) of the basic knowledge management system 10 in addition to further items for enabling the feedback process. When a client/user 160 wishes to report an error, omission, or other flaw in a knowledge document (110, 190), the user must first select or activate the feedback process 200. The feedback process captures the identity of the user 160 and enables the client/user 160 to compose a text message 210 that describes a problem(s) with the current document (110, 190). After the client/user 160 has composed the text message 210, the client/user 160 must select or activate the feedback submission process 220. The submission process 220 deposits a copy 240 of the message 210 in a tracking database 250. The tracking database 250 also includes records 260 for all registered authors 120. The author's record 260 in the tracking database (250) includes the author's e-mail address and a list of document IDs that identify all documents for which the author 120 has responsibility. In this example, the submission process 220 also extracts a document ID 230 from the currently open knowledge document 190. The document ID 230 is used to identify all authors (120, 260) who are responsible for the current document 190. A document may have multiple authors. An e-mail message 270 is then sent to each author 120 responsible for the content of the knowledge document (110, 190). The e-mail message 270 contains a look up pointer (database-link) 280 to the client/user's comments 240 in the tracking database 250.

Following some undetermined delay, the author(s) 120 may read the e-mail message 270. When the author 120 opens the e-mail message 270, the author 120 may use the pointer/database-link 280 contained in the e-mail message 270 to read the comments 240 composed by the client/user 160. Based on the author's evaluation of the merits of the message 240, the author may choose to ignore the message, or to modify the associated knowledge document 110. If the author 120 decides to modify the knowledge document 110, the author may use the formal document authoring/composing system 130 to make appropriate changes to this document. After possible review by supervisors, the revised document may be published to the document repository 100. Although the process employed in knowledge management system 20 makes it possible for a client/user 160 to influence the content of documents 110, the process is very slow and requires active participation by at least one person 120 in addition to the client/user 160. A week may pass between detection of feedback 200 by the author 120 that there is a flaw in the document 110, and the replacement of the flawed document with a corrected document being deposited/published 150. In the interim, other users will continue to be misinformed by the erroneous information in the flawed document.

### SUMMARY OF THE INVENTION

Embodiments of the present invention include a method and system for modifying knowledge documents, wherein the method includes: retrieving an authored document per a client request; wiki-fying a copy of the retrieved authored document; accepting client comments into the wiki-fied authored document while maintaining the integrity of the authored documents; notifying one or more authors of the authored document of the client comments in the wiki-fied copy of the authored document; modifying the authored document based on the determination of the one or more authors to the validity of the client comments; and replacing the authored document with the modified authored document.

A system for knowledge management, the system includes: a document repository containing authored documents; a software interface for facilitating user and author interaction with the document repository; wherein the software interface wiki-fies a copy of an authored document requested by the user that enables the user to add in-line comments within the context of the authored document, while maintaining the integrity of the authored documents; wherein the software interface notifies one or more authors of the authored document of the user comments in the wiki-fied copy of the authored document; and wherein the one or more authors employ the software interface to modify the authored document based on the determination of the one or more authors to the validity of the user comments.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a knowledge management system with the capabilities of permitting users to modify knowledge documents with comments, while preserving the integrity of each knowledge document as composed by the document authors. The present invention enables user participation in knowledge document development and expedites the formal knowledge authoring and revision process.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic diagram of an existing knowledge management system.

FIG. 2 is a schematic diagram of the existing knowledge management system of FIG. 1 with a feedback process.

FIG. 3 is a schematic diagram of a knowledge management system with a user-comment process according to an embodiment of the invention.

FIG. 4 illustrates an example of a knowledge document as seen by a user according to an embodiment of the invention.

FIG. 5 illustrates an example of a wiki-fied knowledge document, as seen by a user according to an embodiment of the invention.

FIG. 6 illustrates an example of a knowledge document with a user-supplied comment according to an embodiment of the invention.

The detailed description explains the preferred embodiments of the invention, together with advantages and features, by way of example with reference to the drawings.

### DETAILED DESCRIPTION

Embodiments of the invention provide a means for a knowledge management system with the capabilities of permitting users to modify knowledge documents with comments, while preserving the integrity of each knowledge document as composed by the document authors. The present invention enables user participation in knowledge document development, and expedites the formal knowledge authoring and revision process. The user participation in the knowledge document development may be carried out on various types of networks including: the Internet, intranets, local area networks (LAN), and wireless local area networks (WLAN).

Embodiments of the invention provide a user with the ability to insert a comment at a selected point in a document, and to deposit the modified document in place of the original document. The modified document becomes instantly visible to other users and no human intervention is involved. In addition, the document author is notified by means such as an e-mail message that a particular document has been modified. The notification enables the document author to review the comment and respond as needed according to the judgment of the author.

In addition, embodiments of the invention provide a method of wiki-fying documents to enable adding in-line comments to a document in legacy knowledge bases that are not wiki-enabled. A legacy knowledge base is a knowledge base created prior to the software coding necessary to present a wiki-enabled documents, and contains legacy documents. Legacy documents are documents created without the software required for wiki-enablement. Wiki-fying a document enables a document to be written collaboratively, in a simple markup language. A wiki-enabled document is a document that has undergone the wiki-fying process and may be used for collaborative editing of documents. A wiki-fied document is a presentation of the original legacy document with additional capabilities, such as inserting comments and providing notification of content changes. When inserting a comment, a user interacts with the wiki-fied document, and the legacy document stored in the knowledge base is not altered.

Finally, embodiments of the invention protect the integrity of the documents in the knowledge base by: (1) recording the identity of the user who submits a comment; (2) preventing users from modifying or deleting any part of the original document, and only permitting additions to the original document; (3) identifying user comments as uncontrolled or unverified content; and (4) immediately notifying the document author of a user comment so that the value or accuracy of the comment may be verified, and to quickly identify malicious or other problematic comments.

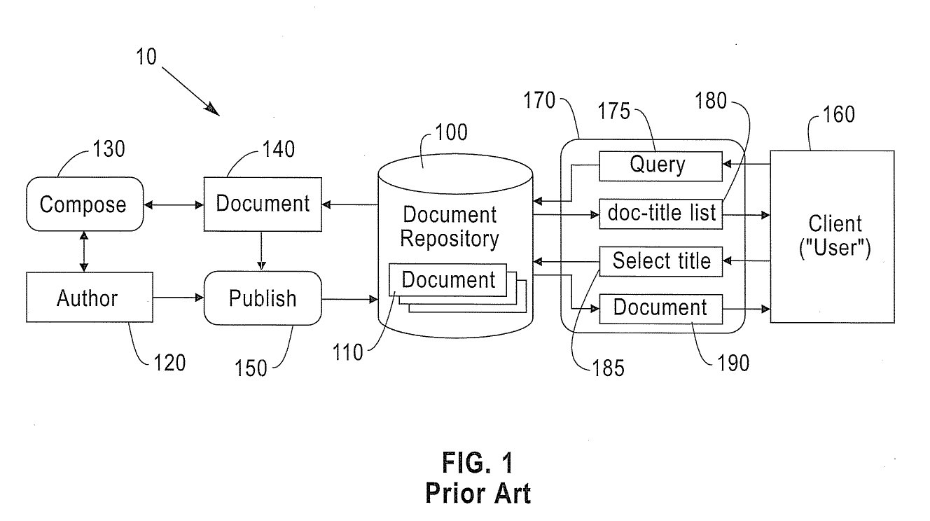

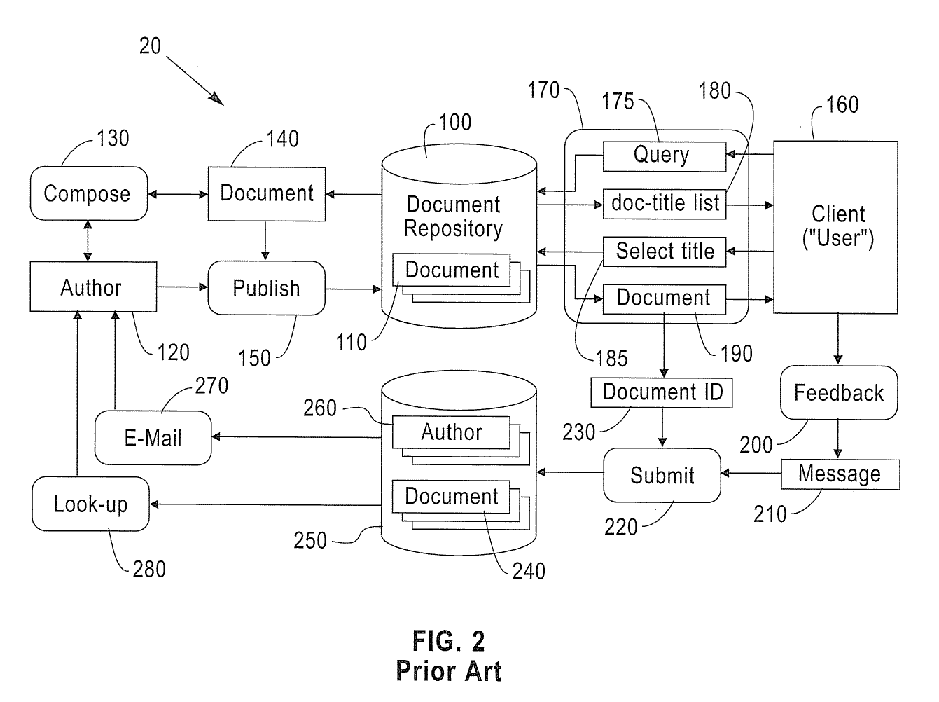

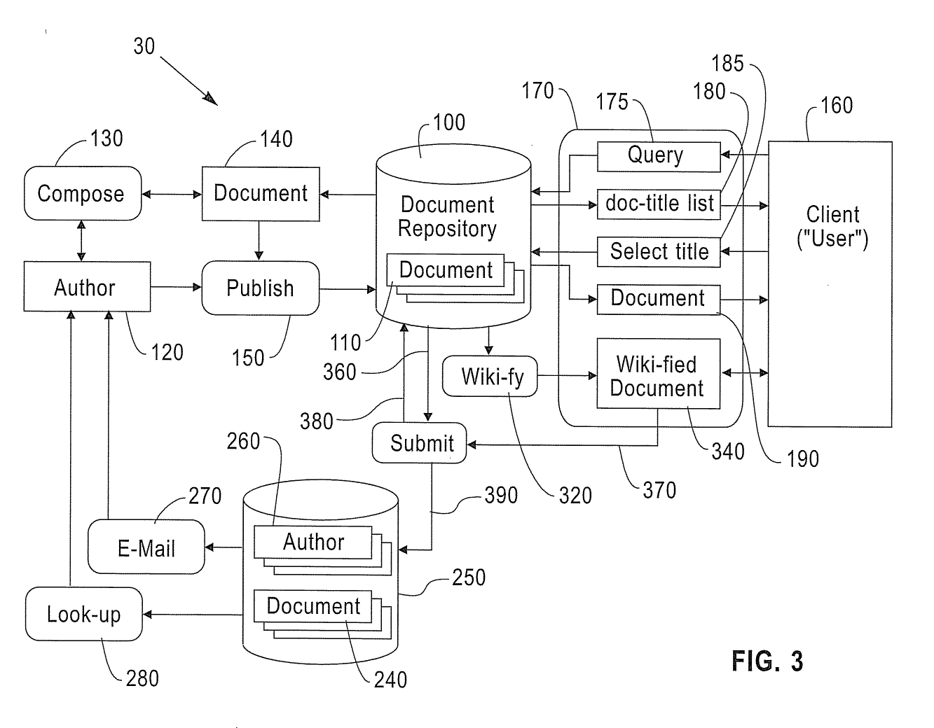

A knowledge management system 30 is shown in FIG. 3 according to an embodiment of the invention. The knowledge management system 30 includes all of the elements (100-160) of the conventional knowledge management systems (10, 20) as shown in FIGS. 1 and 2, as well as some of the components of the feedback mechanism (240-280) of FIG. 2.

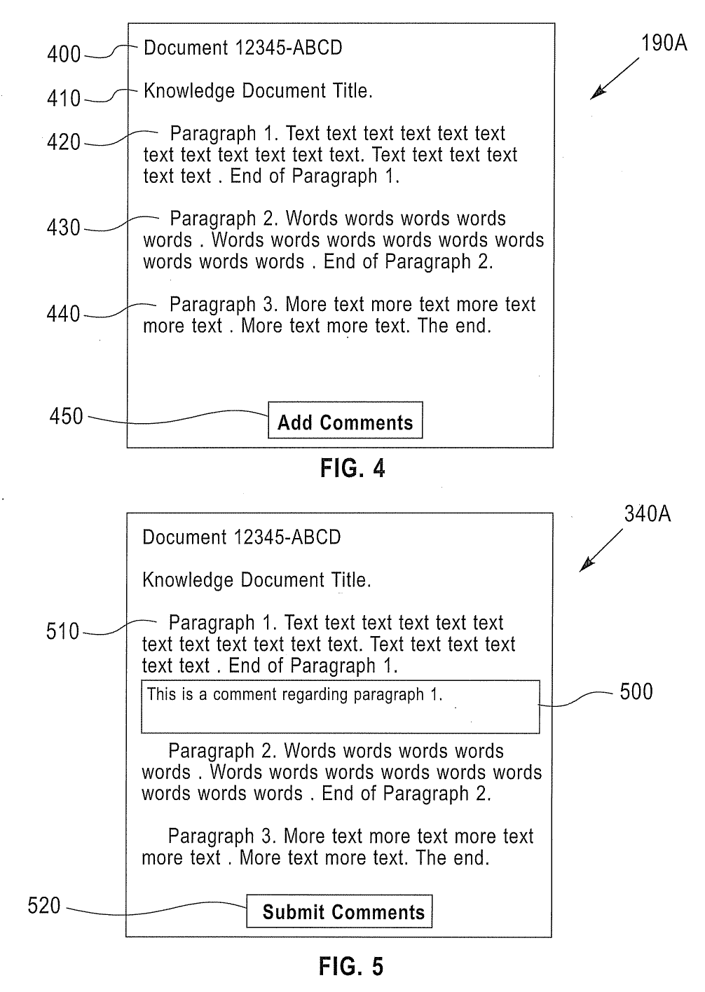

An example of a knowledge document 190A that may be presented to the client/user (160) in the knowledge management system 30 is illustrated in FIG. 4. The knowledge document 190A includes a header 400, a document title 410, and document content (shown as three paragraphs (420, 430, 440)). A user selection interface 450 that may be in the form of a graphical user interface (GUI) such as an anchor-tag hyperlink or button labeled with “Add Comments” is located at the bottom of the knowledge document 190. It is noted that the precise text used to label the user selection interface 450 may vary, and this item is not necessarily located at the end of the document. The knowledge document 190A configuration shown in FIG. 4 is merely one example of how this may appear to a client/user 160.

When the client/user 160 selects (e.g., clicks on) the “Add Comments” button of the user selection interface 450, the “Add Comments” process starts by presenting a “wiki-fied document” 340 to the client/user 160. In one embodiment of the invention, the client/user 160 is presented with a wiki-fied document 340 in place of the original document 190. In an alternative embodiment, the wiki-fied document 340 appears in a new window along-side the original document 190. In the knowledge management system 30, each knowledge document 110 stored in the document repository 100 includes software coding which supports adding new content. The software coding may include appropriate html tags to define places where comments may be inserted. Initially, the software coding support is disabled in the basic presentation of the document 190, and a “wiki-fy” process 320 enables the software coding provided for adding new comments resulting in the wiki-fied document 340. If a knowledge document 110 lacks software coding for enabling the addition of comments (e.g., a legacy document created prior to the implementation of knowledge management system 30), the wiki-fy process 320 extracts a copy of the knowledge document 110 from the document repository 100 and modifies the copy so as too add the required software coding to support client/user 160 comments. The resulting wiki-fied document 340 is then presented to the client/user 160 in place of the document 190, or in a new window.

When the wiki-fied document 340 is presented to the client/user 160, the client/user 160 may select any point in the document where the addition of comments is permitted. This selection may be accomplished by any one of various means such as clicking, double-clicking, or mouse-over events. FIG. 5 presents an example of a wiki-fied document 340A in which the first paragraph 510 has been selected as the object of a comment. In this example, an empty “text-area” box 500 appears below the selected portion of the wiki-fied document 340A. The client/user 160 may then enter any text in the text area box 500. In this example, the client/user 160 has entered the text “This is a comment regarding paragraph 1.”

In place of the “Add Comments” item of the user selection interface 450 seen in FIG. 4, the wiki-fied document 340 has a “Submit Comments” item 520. When this item is selected, the Submit Comments process 350 is performed. This process begins (360) by extracting a fresh copy of the knowledge document 110 from the document repository 100. The new text that has been entered by the user is then extracted (370) from the wiki-fied document 340 and inserted into the new copy of the knowledge document to create a modified knowledge document compatible with all requirements of the document repository 100. The resulting modified document is then deposited (380) in the document repository 100. The wiki-fied document 340 is then closed or removed from the user's screen, and the presentation of the knowledge document 190 is updated to show the modified document. In addition, the new text is recorded in a tracking database 250, and a document ID 260 for the selected document is used to identify the author(s) 120 of the document, or other persons responsible for the content of this particular document. An e-mail message 270 is then generated and sent to the author(s) 120 and responsible parties. The e-mail message 270 contains a look up pointer (database-link) 280 to the client/user's comments 240 in the tracking database 250.

Following some unspecified delay, the author(s) 120 may read the e-mail message 270. When the author 120 opens the e-mail message 270, the author 120 may use the look up pointer 280 contained in the e-mail message 270 to read the comments 240 composed by the client/user 160. Based on the author's evaluation of the merits of the message 240, the author may choose to ignore the message, or to modify the associated knowledge document 110. If the author 120 decides to modify the knowledge document 110, the author may use the formal document authoring/composing system 130 to make appropriate changes to this document. After possible review by supervisors, the revised document may be published to the document repository 100.

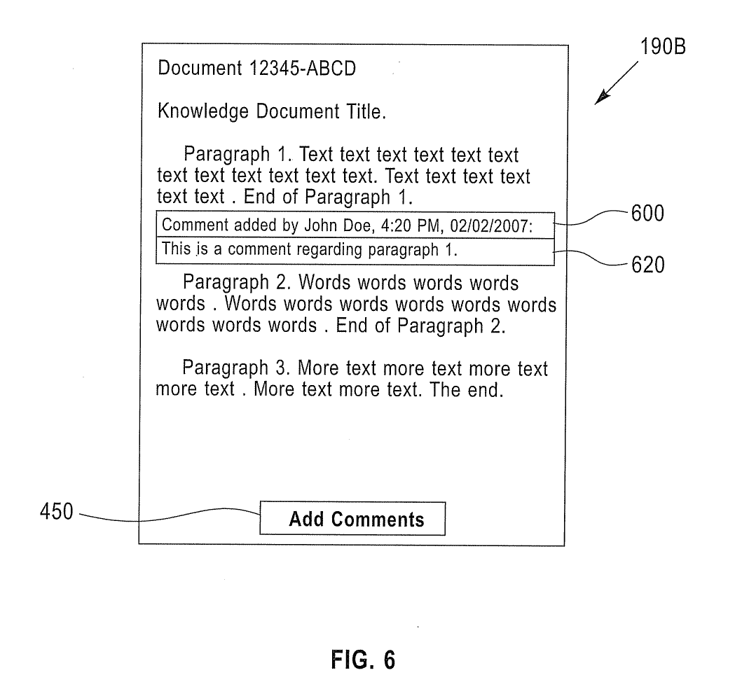

FIG. 6 provides an example of how the modified document 190B may appear to the client/user 160. In this example, a new text box appears at the point selected by the client/user 160. This text box includes the new text 620 entered by the client/user 160 when viewing the wiki-fied document 340. In addition, in this example, the user's comments are accompanied by a header 600, which identifies the user who added the text, as well as the time and date when the comment was added.

In additional embodiments of the invention, each knowledge document 110 that is stored in the document repository 100 contains multiple knowledge fields. When a document is presented to the client/user 160, only the latest entry in this sequence of knowledge fields is shown to the client/user 160. In yet another embodiment of the invention, each knowledge document 110 stored in the document repository 100 contains at least two knowledge fields. The first knowledge field is locked and contains the original knowledge field as composed by the document author 120, while the second or last field is replaced by the modified document as part of the comment submission process (350-380).

The steps involved in extracting a fresh copy of the document (last knowledge field) 360 from the document repository 100, creating a modified document incorporating new user comments, and copying the modified document (knowledge field) 380 into the document repository 100 is very fast and does not depend on factors such as how fast the user can enter the comments. This minimizes the possibility that another user is trying to modify the same document at the same time, and this also minimizes the time that it would be necessary to lock the document to prevent one user from overwriting the comments provided by another user. In an instance where a knowledge document is “wiki-fied” by a first user, but the comments are not yet reviewed by the original author (or are ignored), and a second user wishes to make comments to the original document, the second user sees the “wiki-fied” document created by the first user.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for modifying knowledge documents, the method comprising:
retrieving an authored document per a client request;
presenting a wiki-fied copy of the retrieved authored document to the requesting client;
accepting client comments into the wiki-fied authored document while maintaining the integrity of the authored documents;
notifying one or more authors of the authored document of the client comments in the wiki-fied copy of the authored document;
modifying the authored document based on a communication from the one or more authors to the validity of the client comments;
replacing the authored document with the modified authored document; and
wherein the maintaining the integrity of the authored documents comprises one or more of:
recording the identity of the clients who submit comments;
allowing the clients to add comments to the wiki-fied authored document without modifying any part of the of the original authored document;
identifying client comments as uncontrolled or unverified; and
notifying the one or more document authors of client comments so as to enable verification of the value or accuracy thereof, and to enable identification of problematic comments.

2. The method of claim 1, wherein wiki-fying the authored document adds software coding that enables adding in-line client comments within the context of the authored document; and
wherein the client comments are inserted into the wiki-fied authored document by clicking on the location where the client wants to insert their comment.

3. The method of claim 1, wherein wiki-fying the authored document adds graphical user interface features to facilitate the addition of comments to the wiki-fied authored document.

4. The method of claim 1, wherein notifying the one or more authors is carried out by e-mail.

5. The method of claim 1, wherein the client comments are displayed to other users in real time.

6. The method of claim 1, wherein modifying the knowledge document is carried out over networks comprising: the Internet, intranets, local area networks (LAN), and wireless local area networks (WLAN).

7. A knowledge management system, the system comprising:
a document repository containing authored documents;
a software interface configured to facilitate user and author interaction with the document repository;
wherein the software interface presents a wiki-fied copy of an authored document requested by the user that enables the user to add in-line comments within the context of the authored document, while maintaining the integrity of the authored documents;
wherein the software interface notifies one or more authors of the authored document of the user comments in the wiki-fied copy of the authored document;
wherein the software interface is configured to permit the one or more authors to modify the authored document based on the determination of the one or more authors of the validity of the user comments; and
wherein the maintaining the integrity of the authored documents comprises one or more of:
recording the identity of the clients who submit comments;
allowing the clients to add comments to the wiki-fied authored document without modifying any part of the of the original authored document;
identifying client comments as uncontrolled or unverified; and
notifying the one or more document authors of client comments so as to enable verification of the value or accuracy thereof, and to enable identification of problematic comments.

8. The system of claim 7, wherein wiki-fying the authored document adds software coding that enables adding in-line user comments within the context of the authored document; and
wherein the user comments are inserted into the wiki-fied authored document by clicking on the location where the user wants to insert their comment.

9. The system of claim 7, wherein wiki-fying the authored document adds graphical user interface features to facilitate the addition of comments to the wiki-fied authored document.

10. The system of claim 7, wherein notifying the one or more authors is carried out by e-mail.

11. The system of claim 7, wherein the user comments are displayed to other users in real time.

12. The system of claim 7, wherein the knowledge management is carried out over networks comprising: the Internet, intranets, local area networks (LAN), and wireless local area networks (WLAN).
